(19) United States
(12) Patent Application Publication
(10) Pub. No.: US 2012/0008057 A1
(43) Pub. Date: Jan. 12, 2012

(54) Lens array unit and image display device

(75) Inventors: Kenichi Takahashi, Kanagawa (JP); Yoshihisa Sato, Saitama (JP); Sho Sakamoto, Tokyo (JP)

(73) Assignee: Sony Corporation, Tokyo (JP)

(21) Appl. No.: 13/067,320

(22) Filed: May 25, 2011

(30) Foreign Application Priority Data
Jul. 9, 2010 (JP) 2010-156649

(51) Int. Cl. G02B 27/22; G02F 1/29

(52) U.S. Cl. 349/15; 349/200

(57) ABSTRACT

A lens array unit includes: first and second substrates disposed to be opposite to each other with a distance interposed therebetween; first and second electrode groups respectively formed on the surfaces of the first and second substrates facing the second and first substrates and having a configuration in which electrodes extending in first and second directions are arranged in parallel in the width direction at intervals; first and second switch groups respectively connecting first and second voltage generators applying a voltage to the first and second electrode groups to the electrodes of the first and second electrode groups; and a liquid crystal layer disposed between the first substrate and the second substrate, containing liquid crystal molecules having refractive anisotropy, and causing a lens effect by changing the alignment direction of the liquid crystal molecules depending on the voltages applied to the first and second electrode groups.

### FIELD

The present disclosure relates to a lens array unit and an image display device, and more particularly, to a lens array unit and an image display device which can electrically control occurrence of a lens effect for realizing a three-dimensional display.

### BACKGROUND

In the past, methods of realizing a stereoscopic vision by allowing an observer's right and left eyes to view parallax images causing parallax were known. A method in which an observer should necessarily use special glasses for realizing the stereoscopic vision and a method in which an observer does not need to use special glasses were also known.

The method in which special glasses are necessary has been applied to, for example, screening equipment in theaters or television receivers. The method in which special glasses are not necessary has been considered to be applied to displays of portable electronic apparatuses such as a smart phone, a mobile phone, a portable game machine, and a net book computer in addition to the television receiver.

In a specific example of the method in which special glasses are not necessary, an optical device for three-dimensional display deflecting a display image beam from a two-dimensional display device to plural viewing angles is combined with a screen of the two-dimensional display device such as a liquid crystal display.

A lens array in which plural cylindrical lenses are arranged in parallel is known as the optical device for three-dimensional display. For example, in a binocular stereoscopic vision, a stereoscopic effect can be obtained with respect to an observer's sense of sight by allowing right and left eyes to view different parallax images. Accordingly, to realize the stereoscopic effect, plural cylindrical lenses extending in a vertical direction are arranged in parallel in a horizontal direction so as to face a display surface of the two-dimensional display device and a display image beam from the two-dimensional display device is deflected to the right and left to allow the right and left parallax images to properly reach the observer's right and left eyes.

A switchable lens array unit (hereinafter, referred to as “liquid crystal lens array unit”) using a liquid crystal lens was also known in addition to the cylindrical lenses (for example, see JP-A-2008-9370).

The liquid crystal lens array unit can electrically change the exhibition states of a lens effect equivalent to the cylindrical lens. Accordingly, by forming the liquid crystal lens array unit on the screen of a two-dimensional display device, two display modes of a two-dimensional display mode based on a non-lens-effect state and a three-dimensional display mode based on a lens-effect state can be switched to each other.

### SUMMARY

As described above, the three-dimensional display using the liquid crystal lens array unit is considered to be applied to portable electronic apparatuses such as a smart phone. However, in this case, the following requirements should be satisfied.

That is, in some displays of such electronic apparatuses, the display state can be switched to a vertically-long state (a state where the vertical side is longer in the horizontal-to-vertical ratio of a screen) and a horizontally-long state (a state where the horizontal side is longer in the horizontal-to-vertical ratio of a screen). Accordingly, there is a need for realizing a three-dimensional display regardless of the display state.

In addition, it will be convenient if the overall screen can be switched to one of a two-dimensional display mode and a three-dimensional display mode and an area and the other area of the screen can be simultaneously set to the two-dimensional display mode and the three-dimensional display mode and the other, respectively.

In general, since the three-dimensional display is lower in resolution than the two-dimensional display, it can be considered that an image part needing a high resolution is set to the two-dimensional display mode and the other part can be set to a three-dimensional display mode. It can also be considered that an area in which a stock shot including a part not needing a three-dimensional display should be displayed is partially set to a two-dimensional display mode. For example, it can be considered that only a photograph is displayed in a three-dimensional display mode and an explanatory text thereof is displayed in a two-dimensional display mode.

Thus, it is desirable to enable an area of a three-dimensional display mode to be set at any position on a screen, regardless of the direction of the screen (regardless of the vertically-long state or the horizontally-long state of the screen).

According to one embodiment of the present disclosure, there is provided a lens array unit including: first and second substrates that are disposed to be opposite to each other with a distance interposed therebetween; a first electrode group that is formed on the surface of the first substrate facing the second substrate and that has a configuration in which a plurality of electrodes extending in a first direction are arranged in parallel in the width direction at intervals; a first switch group that connects a first voltage generator applying a voltage to the first electrode group to the electrodes of the first electrode group; a second electrode group that is formed on the surface of the second substrate facing the first substrate and that has a configuration in which a plurality of electrodes extending in a second direction other than the first direction are arranged in parallel in the width direction at intervals; a second switch group that connects a second voltage generator applying a voltage to the second electrode group to the electrodes of the second electrode group; and a liquid crystal layer that is disposed between the first substrate and the second substrate, that contains liquid crystal molecules having refractive anisotropy, and that causes a lens effect by changing the alignment direction of the liquid crystal molecules depending on the voltages applied to the first electrode group and the second electrode group, wherein the lens effect of the liquid crystal layer corresponding to an area specified by a line segment parallel to the first direction and a line segment parallel to the second direction is changed by switching the first and second switch groups.

The states of the voltages applied to the first electrode group and the second electrode group may be changed by switching the first and second switch groups and the liquid crystal layer may be electrically switched to any one of a non-lens-effect state where the area specified by the line segment parallel to the first direction and the line segment parallel to the second direction does not cause the lens effect, a first lens state where the lens effect like a first cylindrical lens extending in the first direction is caused, and a second lens state where the lens effect like a second cylindrical lens extending in the second direction is caused.

The liquid crystal layer may be switched to the non-lens-effect state when the plurality of electrodes of the first electrode group are the same potential as the plurality of electrodes of the second electrode group. The liquid crystal layer may be switched to the second lens state when a common voltage is applied to all the plurality of electrodes of the first electrode group and a driving voltage is selectively applied to only the electrodes located at positions corresponding to a lens pitch of the second cylindrical lens among the plurality of electrodes of the second electrode group. The liquid crystal layer may be switched to the first lens state when a common voltage is applied to all the plurality of electrodes of the second electrode group and a driving voltage is selectively applied to only the electrodes located at positions corresponding to a lens pitch of the first cylindrical lens among the plurality of electrodes of the first electrode group.

The first electrode group may include a plurality of first electrodes extending in the first direction with a first width and a plurality of second electrodes extending in the first direction with a second width greater than the first width and may have a configuration in which the first electrodes and the second electrodes are alternately arranged in parallel. The second electrode group may include a plurality of first electrodes extending in the second direction with a first width and a plurality of second electrodes extending in the second direction with a second width greater than the first width and may have a configuration in which the first electrodes and the second electrodes are alternately arranged in parallel.

The liquid crystal layer may be switched to the non-lens-effect state when the plurality of electrodes of the first electrode group are the same potential as the plurality of electrodes of the second electrode group. The liquid crystal layer may be switched to the second lens state when a common voltage is applied to all the plurality of electrodes of the first electrode group and a driving voltage is selectively applied to only the first electrodes among the plurality of electrodes of the second electrode group. The liquid crystal layer may be switched to the first lens state when a common voltage is applied to all the plurality of electrodes of the second electrode group and a driving voltage is selectively applied to only the first electrodes among the plurality of electrodes of the first electrode group.

The liquid crystal layer may be switched to the second lens state when the driving voltage is selectively applied to only the first electrodes among the plurality of electrodes of the second electrode group and the second electrodes are grounded, and may be switched to the first lens state when the driving voltage is selectively applied to only the first electrodes among the plurality of electrodes of the first electrode group and the second electrodes are grounded.

The liquid crystal layer may be switched to the second lens state when the common voltage is applied to all the plurality of electrodes of the first electrode group and a second driving voltage is selectively applied to only the first electrodes among the plurality of electrodes of the second electrode group. The liquid crystal layer may be switched to the first lens state when the common voltage is applied to all the plurality of electrodes of the second electrode group and a first driving voltage is selectively applied to only the first electrodes among the plurality of electrodes of the first electrode group. The first driving voltage and the second driving voltage may be rectangular waves having the same voltage amplitude and may have a phase difference of 180°.

The first electrodes of the first electrode group may be arranged at intervals corresponding to the lens pitch of the first cylindrical lens, and the first electrodes of the second electrode group may be arranged at intervals corresponding to the lens pitch of the second cylindrical lens.

The first direction and the second direction may be perpendicular to each other and the liquid crystal layer may be electrically switched to a lens-effect state in the first direction or a lens-effect state in the second direction.

The second direction may intersect the first direction with an angle of (90°−θ) and the liquid crystal layer may be electrically switched to a lens-effect state in the first direction or a lens-effect state in the second direction.

The θ may be set to satisfy tan⁻¹θ=1/3.

In the one embodiment of the present disclosure, the lens effect of the liquid crystal layer corresponding to the area specified by the line segment parallel to the first direction and the line segment parallel to the second direction is changed by switching the first and second switch groups.

According to another embodiment of the present disclosure, there is provided an image display device including: a display panel that makes a display of an image; a lens array unit that is disposed to be opposite to the display surface of the display panel and that selectively changes a passing state of a light beam from the display panel; detection means for detecting a direction in which the display panel disposed to be opposite to the lens array unit is used; setting means for setting an area on a screen; and switch control means for controlling switches. Here, lens array unit includes first and second substrates that are disposed to be opposite to each other with a distance interposed therebetween, a first electrode group that is formed on the surface of the first substrate facing the second substrate and that has a configuration in which a plurality of electrodes extending in a first direction are arranged in parallel in the width direction at intervals, a first switch group that connects a first voltage generator applying a voltage to the first electrode group to the electrodes of the first electrode group, a second electrode group that is formed on the surface of the second substrate facing the first substrate and that has a configuration in which a plurality of electrodes extending in a second direction other than the first direction are arranged in parallel in the width direction at intervals, a second switch group that connects a second voltage generator applying a voltage to the second electrode group to the electrodes of the second electrode group, and a liquid crystal layer that is disposed between the first substrate and the second substrate, that contains liquid crystal molecules having refractive anisotropy, and that causes a lens effect by changing the alignment direction of the liquid crystal molecules depending on the voltages applied to the first electrode group and the second electrode group. In this case, the switch control means switches the first and second switch groups on the basis of the detected direction in which the display panel is used and the set area on the screen, whereby the lens effect of the liquid crystal layer corresponding to the area is changed.

The states of the voltages applied to the first electrode group and the second electrode group may be changed by switching the first and second switch groups and the liquid crystal layer may be electrically switched to any one of a non-lens-effect state where the area specified by a line segment parallel to the first direction and a line segment parallel to the second direction does not cause the lens effect, a first lens state where the lens effect like a first cylindrical lens extending in the first direction is caused, and a second lens state where the lens effect like a second cylindrical lens extending in the second direction is caused.

A display state may be electrically switched to a two-dimensional display or a three-dimensional display by switching the lens array unit to one of the non-lens-effect state, the first lens state, and the second lens state.

The two-dimensional display may be made by setting the lens array unit to the non-lens-effect state and not deflecting but transmitting a display image beam from the display panel. The three-dimensional display from which a stereoscopic effect can be obtained when both eyes are located in a direction perpendicular to the first direction may be made by setting the lens array unit to the first lens state and deflecting the display image beam from the display panel to the direction perpendicular to the first direction. The three-dimensional display from which a stereoscopic effect can be obtained when both eyes are located in a direction perpendicular to the second direction may be made by setting the lens array unit to the second lens state and deflecting the display image beam from the display panel to the direction perpendicular to the second direction.

In the another embodiment of the present disclosure, the lens effect of the liquid crystal layer corresponding to the set area is changed by switching the first and second switch groups.

According to the one embodiment of the present disclosure, it is possible to obtain a lens effect for realizing an area of a three-dimensional display mode at any position on a screen, regardless of the direction of the screen.

According to the another embodiment of the present disclosure, it is possible to set an area of a three-dimensional display mode at any position on a screen, regardless of the direction of the screen.

### BRIEF DESCRIPTION OF THE DRAWINGS

FIGS. 1A to 1C are diagrams illustrating the appearance of a smart phone according to an embodiment of the present disclosure.

FIG. 2 is a sectional view illustrating the configuration of a liquid crystal lens array unit.

FIG. 3 is a perspective view illustrating first and second electrode groups of the liquid crystal lens array unit.

FIG. 4 is a perspective view illustrating the first and second electrode groups of the liquid crystal lens array unit.

FIG. 5 is a block diagram illustrating the configuration for control of the liquid crystal lens array unit.

FIGS. 6A and 6B are diagrams illustrating a use of a display and voltage application states to electrodes.

FIGS. 7A and 7B are diagrams illustrating a use of a display and voltage application states to electrodes.

FIGS. 8A and 8B are diagrams illustrating a use of a display and voltage application states to electrodes.

FIGS. 9A and 9B are diagrams illustrating a use of a display and voltage application states to electrodes.

FIG. 10 is a diagram illustrating an arrangement of the uses of a display and the voltage application states to electrodes.

FIGS. 11A to 11C are diagrams illustrating waveforms of voltages applied to electrodes.

FIG. 12 is a diagram illustrating an example of a display panel.

FIGS. 13A and 13B are diagrams illustrating the angle formed by a first electrode group and a second electrode group according to first to third examples.

FIGS. 14A and 14B are diagrams illustrating the angle formed by a first electrode group and a second electrode group according to fourth to sixth examples.

FIG. 15 is a diagram illustrating values of parameters in the first to sixth examples.

FIG. 16 is a diagram illustrating a method of evaluating a three-dimensional display.

FIGS. 17A and 17B are diagrams illustrating examples of three-dimensional display areas.

FIG. 18 is a diagram illustrating the evaluation results in the first to sixth examples.

### DETAILED DESCRIPTION

Hereinafter, a mode for carrying out the present disclosure (hereinafter, referred to as an “embodiment”) will be described in detail with reference to the accompanying drawings.

### 1. Embodiment

### [Configuration of Smart Phone]

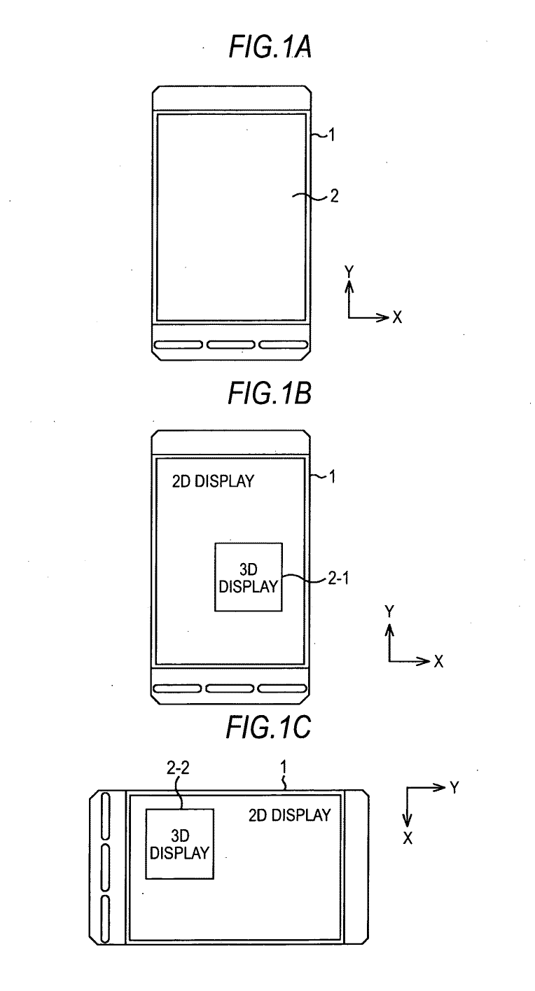

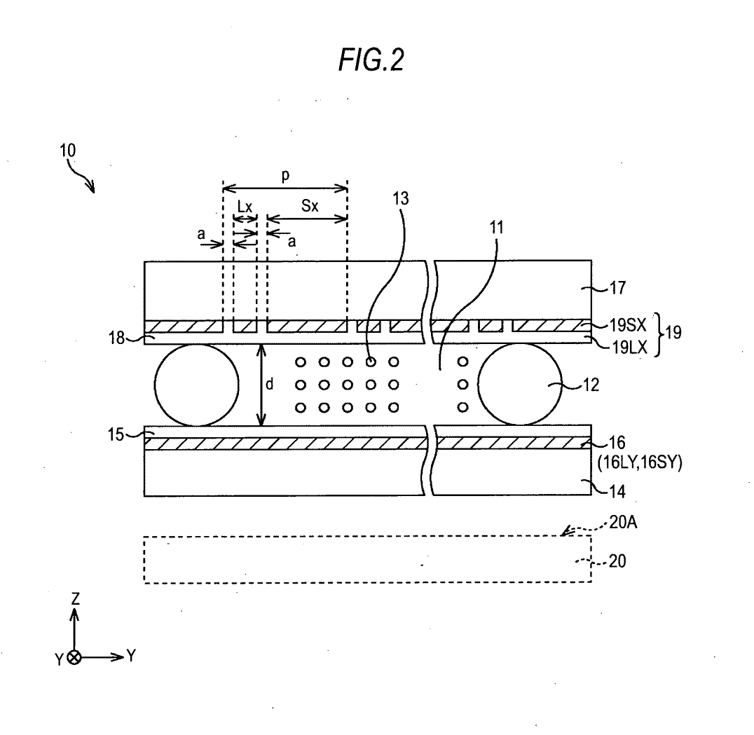

FIGS. 1A to 1C are diagrams illustrating the appearance of a smart phone according to an embodiment of the present disclosure. A display 2 having a horizontal length and a vertical length different from each other is disposed in the smart phone 1. The display 2 includes a display panel 20 which is a two-dimensional display device and a liquid crystal lens array unit 10 (see FIG. 2) disposed on a screen thereof.

The smart phone 1 can be used in a state where the body is set upright, that is, in a state where the display 2 is in a vertically-long state, as shown in FIGS. 1A and 1B. As shown in FIG. 1C, the smart phone 1 can be used in a state where the body is inclined horizontally by 90 degrees, that is, in a state where the display 2 is in a horizontally-long state. The angle of the display content in the display 2 is adjusted in the direction against the inclination of the display 2. Accordingly, a user (observer) of the smart phone 1 can naturally view displayed information, regardless of the inclination of the body.

As shown in FIG. 1B, when the display 2 is in the vertically-long state, a three-dimensional display area 2-1 with any size can be provided at a position on the screen designated by the user. At this time, the area other than the three-dimensional display area 2-1 on the screen serves as a two-dimensional display area.

As shown in FIG. 1C, when the display 2 is in the horizontally-long state, a three-dimensional display area 2-2 with any size can be provided at a position on the screen designated by the user. At this time, the area other than the three-dimensional display area 2-2 on the screen serves as a two-dimensional display area.

Although not shown, a two-dimensional display area with any size may be provided at a position on the screen designated by the user and the other area may be set as a three-dimensional display area.

### [Configuration of Liquid Crystal Lens Array Unit]

FIG. 2 is a sectional view illustrating the configuration of a liquid crystal lens array unit 10 constituting the display 2.

As shown in the drawing, the liquid crystal lens array unit 10 is disposed on a display surface 20A of the display panel 20.

The liquid crystal lens array unit 10 selectively changes a passing state of a light beam from the display panel 20 by controlling the lens effect of each area on the screen in accordance with the display mode thereof.

The display panel 20 can be formed of, for example, a liquid crystal display or an organic EL. The display panel 20 makes a display of an image based on two-dimensional image data in the area of a two-dimensional display mode and makes a display of an image based on three-dimensional image data in the area of a three-dimensional display mode. For example, the three-dimensional image data is data including plural parallax images corresponding to plural viewing angles in a three-dimensional display and represents data of a right-eye parallax image and a left-eye parallax image when a binocular three-dimensional display is made.

The liquid crystal lens array unit 10 includes a first substrate 14 and a second substrate 17 which are disposed to be opposite to each other with a distance d interposed therebetween and a liquid crystal layer 11 disposed therebetween.

The first substrate 14 and the second substrate 17 are transparent substrates formed of, for example, a glass material or a resin material. A first electrode group 16, in which plural transparent electrodes extending in a first direction (the X axis direction in the drawing) are arranged in parallel in a width direction (the Y axis direction in the drawing) at intervals, is formed on the surface of the first substrate 14 facing the second substrate 17. An alignment film 15 is formed on the first substrate 14 with the first electrode group 16 interposed therebetween.

Similarly, a second electrode group 19 in which plural transparent electrodes extending in a second direction (the Y axis direction in the drawing) other than the first direction are arranged in parallel in a width direction (the X axis direction in the drawing) at intervals is formed on the surface of the second substrate 17 facing the first substrate 14. An alignment film 18 is formed on the second substrate 17 with the second electrode group 19 interposed therebetween.

The liquid crystal layer 11 contains liquid crystal molecules 13 and the lens effect thereof is controlled by changing alignment directions of the liquid crystal molecules 13 on the basis of voltages applied to the first electrode group 16 and the second electrode group 19. The liquid crystal layer 11 can electrically switch the liquid crystal lens array unit 10 to three states of a non-lens-effect state, a first lens state, and a second lens state on the basis of the states of the voltages applied to the first electrode group 16 and the second electrode group 19 for each area.

Each liquid crystal molecule 13 has refractive anisotropy and has, for example, a refractive index ellipsoid structure in which the refractive index of a transmitted light beam varies in the longitudinal direction and the transverse direction. The first lens state is a state where a lens effect like a first cylindrical lens extending in the first direction occurs. The second lens state is a state where a lens effect like a second cylindrical lens extending in the second direction occurs.

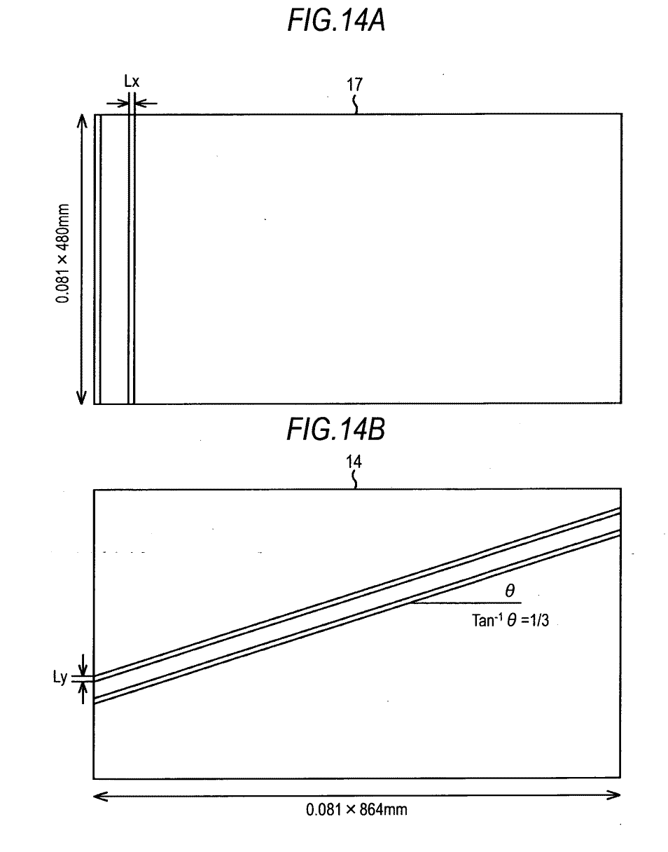

In the following description of this embodiment, it is assumed that the first direction is the X direction (the horizontal direction in the drawing surface) in FIGS. 1A to 1C and the second direction is the Y direction (the direction perpendicular to the drawing surface) in FIGS. 1A to 1C. The X direction and the Y direction are perpendicular to each other in the substrate plane. However, the X direction and the Y direction may not be perpendicular to each other. This case will be described later with reference to FIGS. 14A and 14B.

### [Electrode Structure of Liquid Crystal Lens Array Unit]

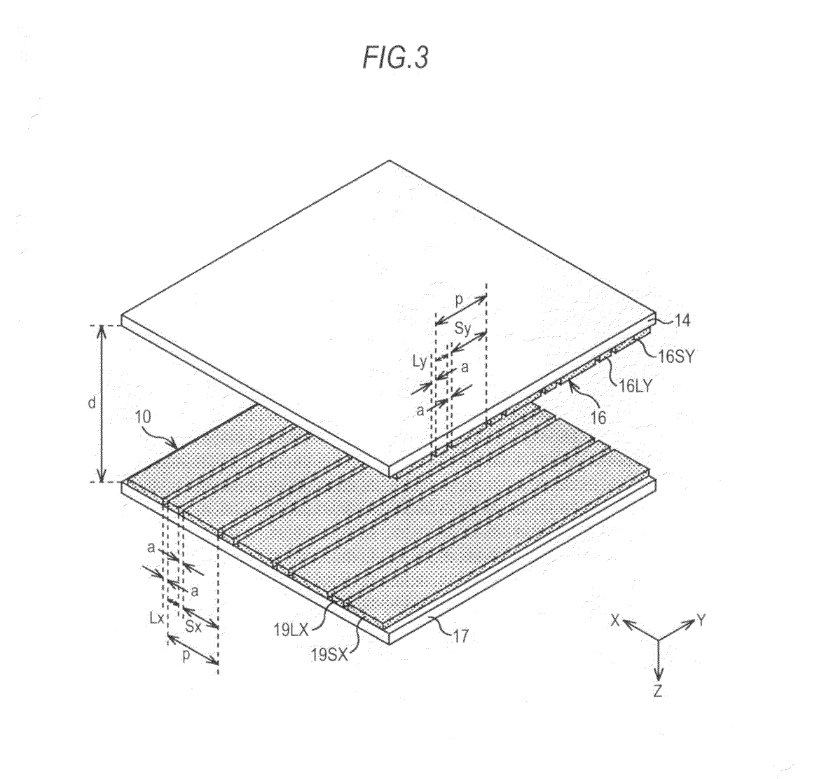

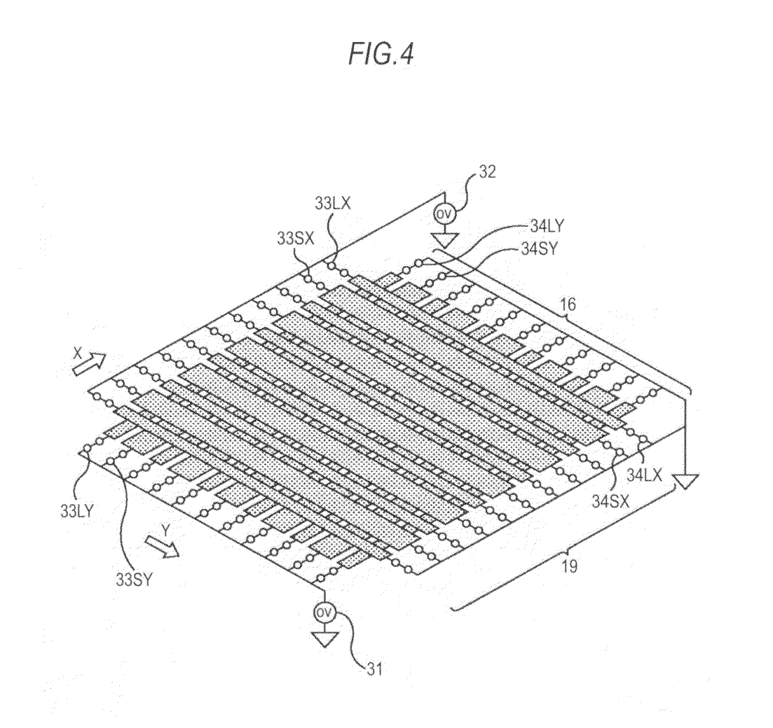

FIGS. 3 and 4 show the electrode structure of the liquid crystal lens array unit 10. FIG. 3 is a state obtained by turning FIGS. 2 and 4 upside down, that is, a state where the first substrate 14 is located on the upside, and the second substrate 17 is located on the downside.

In the first electrode group 16 disposed on the first substrate 14, two types of electrodes having different electrode widths are alternately arranged in parallel as plural transparent electrodes. That is, the first electrode group includes plural X-direction first electrodes (first electrodes 16LY) and plural X-direction second electrodes (second electrodes 16SY) and has a configuration in which the first electrodes 16LY and the second electrodes 16SY are alternately arranged in parallel.

The first electrodes 16LY extend in the first direction (the X direction) with a first width Ly. The second electrodes 16SY extend in the first direction with a second width Sy larger than the first width Ly. The first electrodes 16LY are arranged in parallel at a cycle interval corresponding to the lens pitch p of a first cylindrical lens generated as a lens effect. The first electrodes 16LY and the second electrodes 16SY are arranged with a distance a interposed therebetween.

As shown in FIG. 4, an end of each first electrode 16LY extending in the first direction is connected to an X-line generator 31 applying a predetermined voltage to the first electrode group 16 via a corresponding switch 33LY, and the other end thereof is grounded via a corresponding switch 34LY. An end of each second electrode 16SY is connected to the X-line generator 31 via a corresponding switch 33SY and the other end thereof is grounded via a corresponding switch 34SY.

Similarly, in the second electrode group 19, two types of electrodes having different electrode widths are alternately arranged in parallel as plural transparent electrodes. That is, the second electrode group 19 includes plural Y-direction first electrodes (first electrodes 19LX) and plural Y-direction second electrodes (second electrodes 19SX) and has a configuration in which the first electrodes 19LX and the second electrodes 19SX are alternately arranged in parallel.

The first electrodes 19LX extend in the second direction (the Y direction) with a first width Lx. The second electrodes 19SX extend in the second direction with a second width Sx larger than the first width Lx. The first electrodes 19LX are arranged in parallel at a cycle interval corresponding to the lens pitch p of a second cylindrical lens generated as a lens effect. The second electrodes 19LX and the second electrodes 19SX are arranged with a distance a interposed therebetween.

As shown in FIG. 4, an end of each second electrode 19LX extending in the second direction is connected to a Y-line generator 32 applying a predetermined voltage to the second electrode group 19 via a corresponding switch 33LX, and the other end thereof is grounded via a corresponding switch 34LX. An end of each second electrode 19SX is connected to the Y-line generator 32 via a corresponding switch 33SX and the other end thereof is grounded via a corresponding switch 34SX.

In the above-mentioned configuration, by causing the X-line generator 31 and the Y-line generator 32 to generate a predetermined voltage and properly switching the switches 33LY and 34LY, the switches 33SY and 34SY, the switches 33LX and 34LX, and the switches 33SX and 34SX, any area of the liquid crystal lens array unit 10 can be set to a two-dimensional display mode or a three-dimensional display mode.

By not causing the X-line generator 31 and the Y-line generator 32 to generate a predetermined voltage, that is, by not supplying the liquid crystal lens array unit 10 with power, the overall area of the liquid crystal lens array unit 10 can be set to the two-dimensional display mode regardless of its direction.

In consideration of the typical use of the smart phone 1, it is thought that the state where the overall area of the liquid crystal lens array unit 10 is set to the two-dimensional display mode occupies the longest time in the use time thereof. Therefore, compared with the configuration in which the liquid crystal lens array unit 10 is normally supplied with power to set the overall area thereof to the two-dimensional display mode, it is possible to suppress power consumption.

### [Manufacturing of Liquid Crystal Lens Array Unit]

When the liquid crystal lens array unit 10 is manufactured, transparent conductive films such as an ITO (Indium Tin Oxide) film are formed in predetermined patterns on the first substrate 14 and the second substrate 17 formed of a glass material or the like to form the first electrode group 16 and the second electrode group 19. The alignment films 15 and 18 are formed by the use of a rubbing method of rubbing high-molecular compounds such as polyimide in a direction with cloth or an oblique deposition method of SiO. Accordingly, the long axis of an ellipse of the liquid crystal molecule 13 can be aligned in the direction.

To keep the distance d between the first substrate 14 and the second substrate 17 constant, a material in which spacers 12 formed of a glass material or a resin material are dispersed in a sealing member is printed on the alignment films 15 and 18. Then, the first substrate 14 and the second substrate 17 are bonded to each other and the sealing member containing the spacers is cured. Thereafter, a predetermined liquid crystal material is injected between the first substrate 14 and the second substrate 17 from a sealing member opening and the sealing member opening is then closed. The liquid crystal composition is heated up to the isotropic phase and is then slowly cooled, whereby the liquid crystal lens array unit 10 is completed.

In the liquid crystal lens array unit 10, since a more excellent lens effect can be obtained as the refractive anisotropy Δn of the liquid crystal molecules 13 increases, the liquid crystal material can preferably have such a composition. On the other hand, when a liquid crystal composition has great refractive anisotropy Δn, the physical properties of the liquid crystal composition are damaged and the viscosity thereof increases. Accordingly, the liquid crystal composition may not be injected well between the substrates, the liquid crystal composition may become close to crystal at a low temperature, or the internal electric field thereof may increase, thereby enhancing the driving voltage of the liquid crystal unit. Therefore, it is preferable that the composition of the liquid crystal material is determined in consideration of both the manufacturability and the lens effect. The specific composition of the liquid crystal material will be described in detail in examples to be described later.

### [Configuration of Liquid Crystal Lens Array Unit Controller]

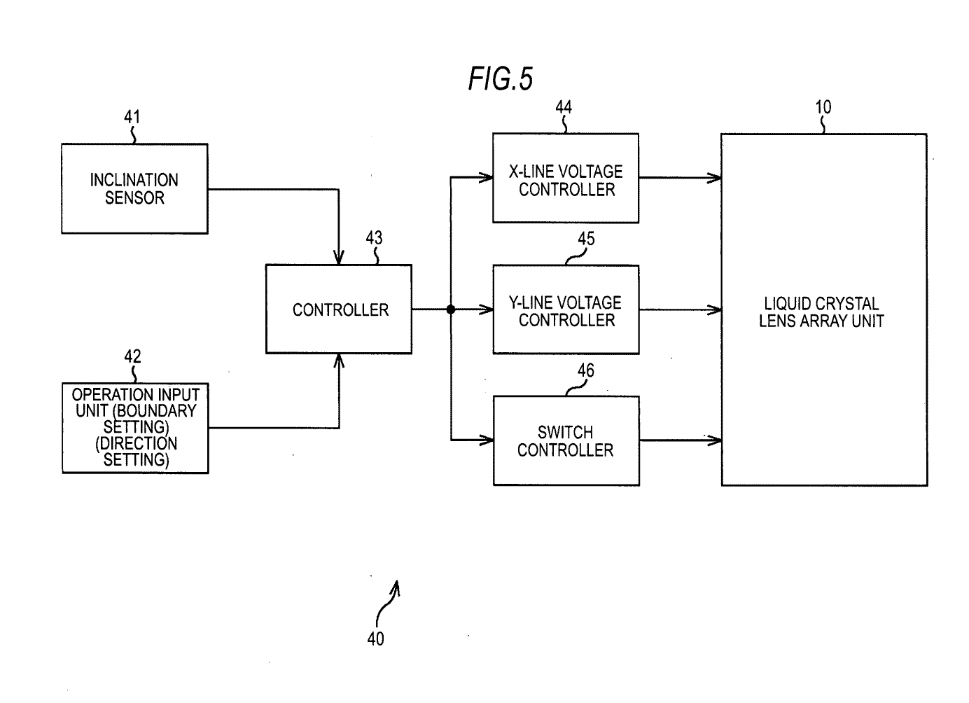

FIG. 5 is a diagram illustrating the configuration of a liquid crystal lens array unit controller disposed in the smart phone 1 so as to control the liquid crystal lens array unit 10.

The liquid crystal lens array unit controller 40 includes an inclination sensor 41, an operation input unit 42, a controller 43, an X-line voltage controller 44, a Y-line voltage controller 45, and a switch controller 46.

The inclination sensor 41 detects an inclination of the body of the smart phone 1 and sends the detection result to the controller 43. The operation input unit 42 receives a user's operation of designating an area to be set to a three-dimensional display mode (hereinafter, also referred to as “three-dimensional display area”) or designating a display direction of the display 2 and outputs an operation signal corresponding to the operation to the controller 43.

The controller 43 determines the display direction of the display 2 and determines the three-dimensional display area provided onto the screen of the display 2, on the basis of the detection result of the inclination sensor 41 or the operation signal from the operation input unit 42.

The determination may be made on the basis of the detection result of the inclination sensor 41 and the control of an application in execution without depending on the operation signal based on the user's operation. The controller 43 controls the X-line voltage controller 44, the Y-line voltage controller 45, and the switch controller 46 on the basis of the determination.

The X-line voltage controller 44 controls the X-line generator 31 to generate a predetermined voltage under the controlof the controller 43. The Y-line voltage controller 45 controls the Y-line generator 32 to generate a predetermined voltage under the control of the controller 43. The switch controller 46 switches the switches 33Ly and 34LY, the switches 33SY and 34SY, the switches 33LX and 34LX, and the switches 33SX and 34SX, which are connected to the first electrode group 16 and the second electrode group 19, under the control of the controller 43.

### [Switch Control Corresponding to State of Display and Display Mode]

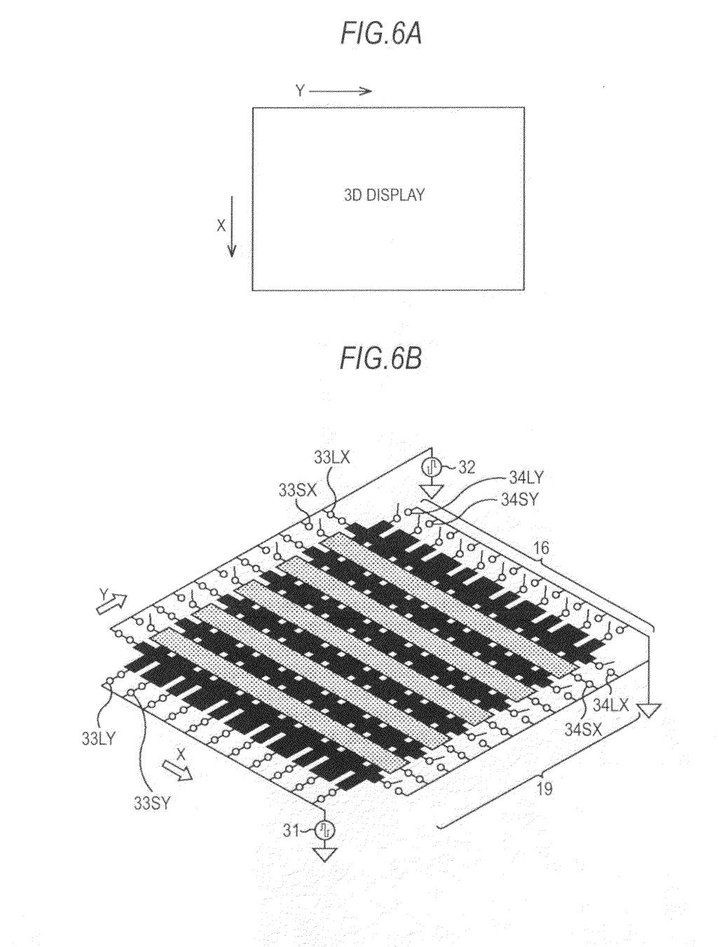

The states of the switches 33Ly and 34LY, the switches 33SY and 34SY, the switches 33LX and 34LX, and the switches 33SX and 34SX corresponding to the state of the display 2 (whether it is used in the vertically-long state or in the horizontally-long state) and the display mode (the two-dimensional display mode or the three-dimensional display mode) will be described below with reference to FIGS. 6A and 6B to FIGS. 9A and 9B.

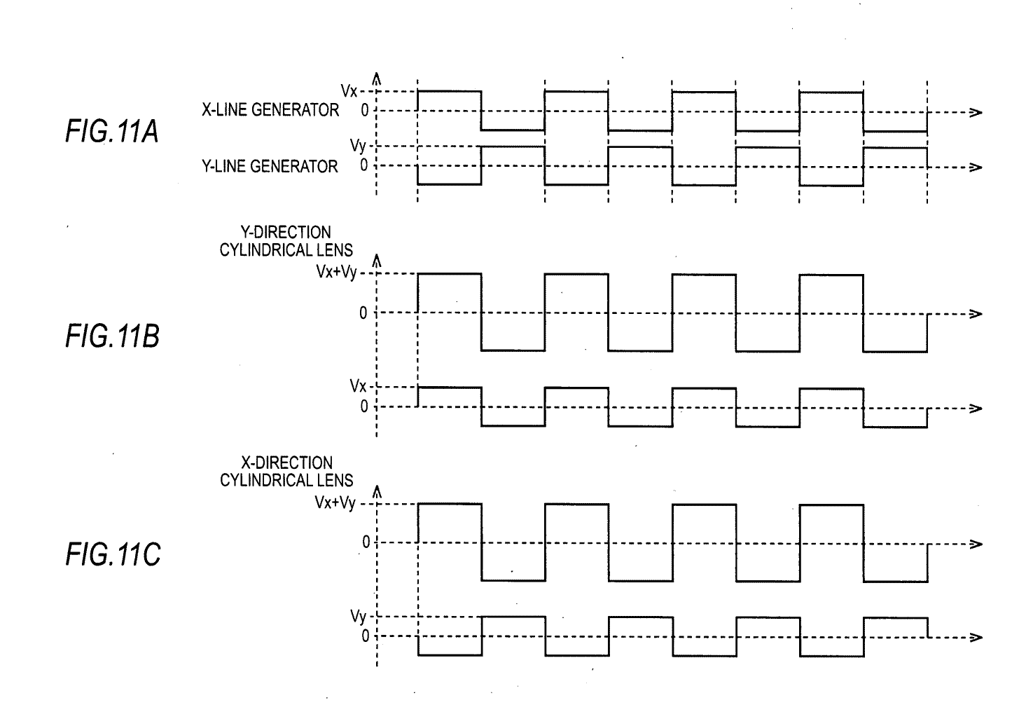

It is assumed that the X-line generator 31 and the Y-line generator 32 in FIGS. 6A and 6B to FIGS. 9A and 9B generate predetermined voltages (which will be described later with reference to FIGS. 11A to 11C), respectively. In FIGS. 6A and 6B to FIGS. 9A and 9B, the electrodes supplied with the predetermined voltage are marked by black and the electrodes not supplied with the predetermined voltage are marked by dots.

As shown in FIG. 6A, when the display 2 is used in the horizontally-long state and the overall surface is set to the three-dimensional display mode, all the electrodes of the first electrode group 16 are supplied with the predetermined voltage as shown in FIG. 6B. All the first electrodes 19LX with a smaller width in the second electrode group 19 are supplied with the predetermined voltage.

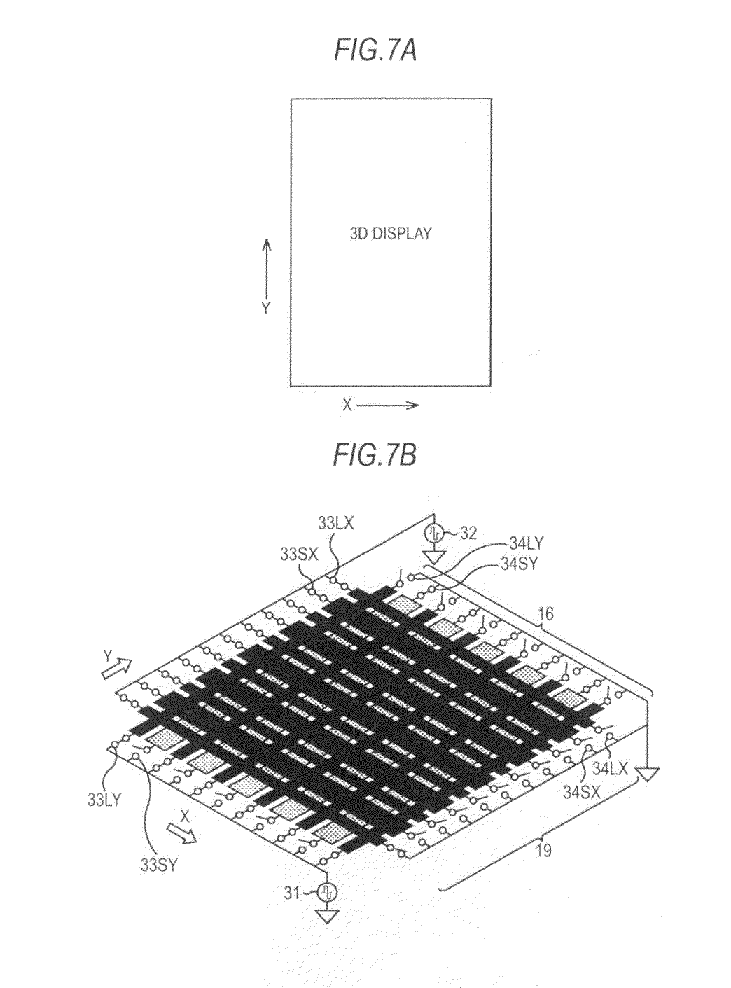

As shown in FIG. 7A, when the display 2 is used in the vertically-long state and the overall surface is set to the three-dimensional display mode, all the first electrodes 16LY with a smaller width in the first electrode group 16 are supplied with the predetermined voltage as shown in FIG. 7B. All the electrodes of the second electrode group 19 are supplied with the predetermined voltage.

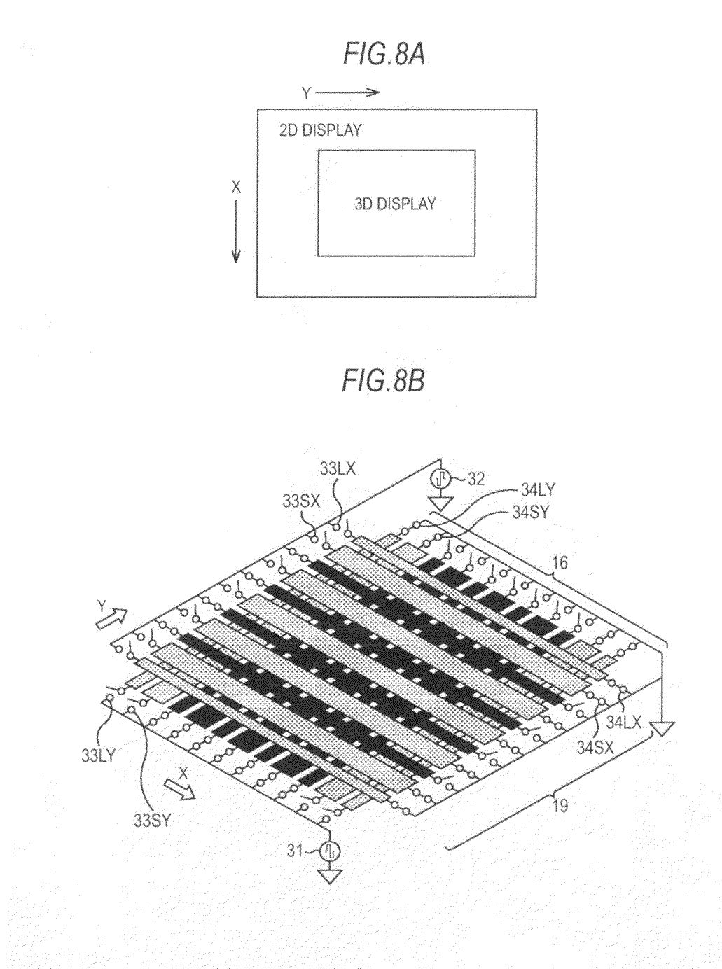

As shown in FIG. 8A, when the display 2 is used in the horizontally-long state and a three-dimensional display area with an arbitrary size is provided at an arbitrary position, the first electrodes 16LY and the second electrodes 16SY corresponding to the three-dimensional display area in the first electrode group 16 are supplied with the predetermined voltage as shown in FIG. 8B. Only the first electrodes 19LX corresponding to the three-dimensional display area in the second electrode group 19 are supplied with the predetermined voltage.

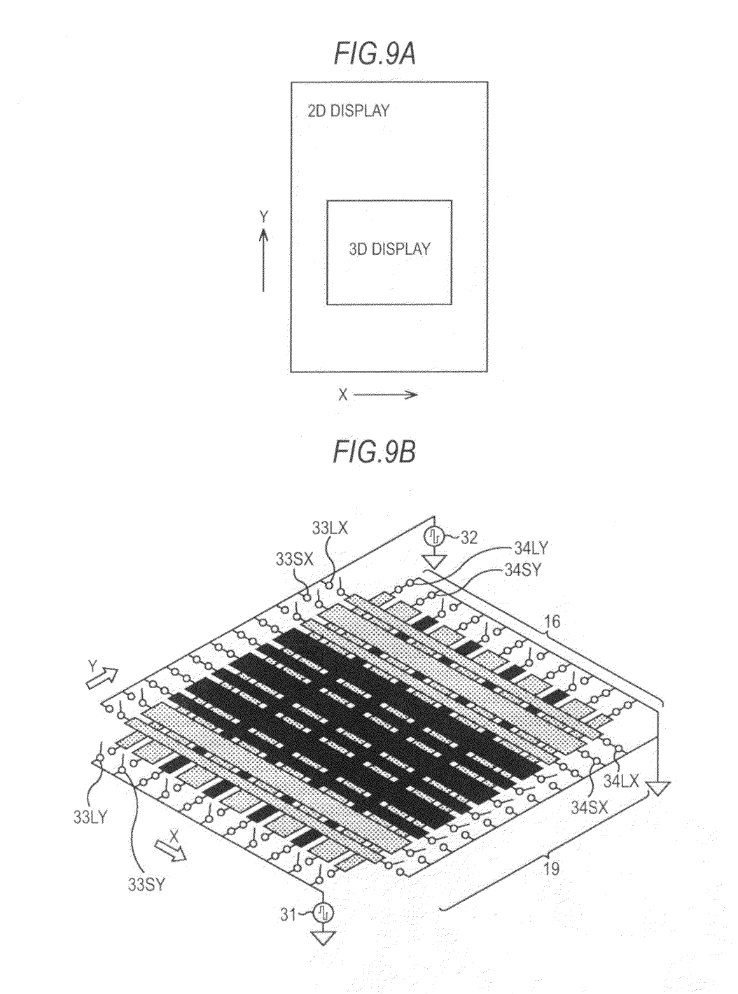

As shown in FIG. 9A, when the display 2 is used in the vertically-long state and a three-dimensional display area with an arbitrary size is provided at an arbitrary position, only the first electrodes 16LY corresponding to the three-dimensional display area in the first electrode group 16 are supplied with the predetermined voltage as shown in FIG. 9B. The first electrodes 19LX and the second electrodes 19SX corresponding to the three-dimensional display area in the second electrode group 19 are supplied with the predetermined voltage.

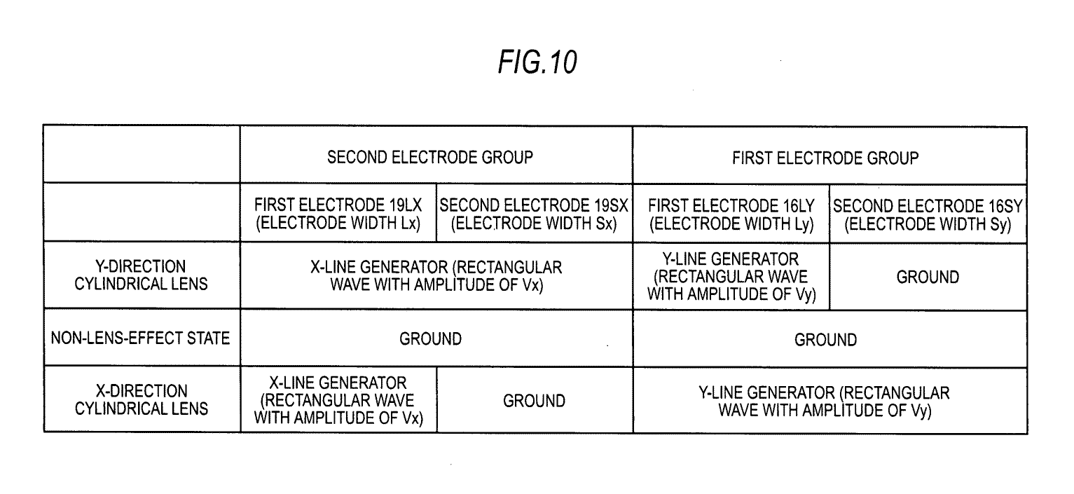

FIG. 10 shows the relation between the voltage application states to the electrodes and the generated lens effect in the liquid crystal lens array unit 10 shown in FIGS. 6A and 6B to FIGS. 9A and 9B.

As described above, in the liquid crystal lens array unit 10 according to this embodiment, it is possible to provide a three-dimensional display area with any size at any position on the screen, regardless of the state (the vertically-long state or the horizontal-long state) of the display 2.

[Voltages Generated from X-Line Generator and Y-Line Generator]

The voltages gene'rated from the X-line generator 31 and the Y-line generator 32 and applied to the electrodes will be described below with reference to FIGS. 11A to 11C.

FIG. 11A shows an example of voltage waveforms generated from the X-line generator 31 and the Y-line generator 32. As shown in FIG. 11A, the X-line generator 31 generates a voltage of a rectangular waveform with a frequency of 30 Hz or higher in the order of +Vx, −Vx, +Vx, −Vx, . . . . On the contrary, the Y-line generator 32 generates a voltage of a rectangular waveform with the same period in the order of −Vy, +Vy, −Vy, +Vy . . . . That is, the X-line generator 31 and the Y-line generator 32 generate the voltages with almost the same amplitude (Vx=Vy) and with different phases by 180°.

FIG. 11B shows the potentials of the electrodes in the vertical direction corresponding to the state shown in FIG. 6A. Specifically, the upper side of FIG. 11B shows the voltage waveform of a part corresponding to the first electrodes 19LX of the second electrode group 19 and the lower side of FIG. 11B shows the voltage waveform of a part corresponding to the second electrodes 19SX.

When the state shown in FIG. 6A is realized, a predetermined potential difference allowing the liquid crystal molecules 13 to cause an alignment variation is generated in the part corresponding to the first electrodes 19LX of the second electrode group 19 between the upper and lower transparent electrodes with the liquid crystal layer 11 interposed therebetween.

Specifically, the switches, which are close to the X-line generator 31, of the electrodes constituting the first electrode group 16 are all turned on to apply a common voltage (with an amplitude Vx) thereto. Among the plural electrodes constituting the second electrode group 19, only the first electrodes 19LX are connected to the Y-line generator 32 to selectively apply the voltage (with an amplitude Vy) thereto. The second electrodes 19SX among the plural electrodes constituting the second electrode group 19 are grounded.

Here, when the X-line generator 31 and the Y-line generator 32 generate the voltages shown in FIG. 11A, a rectangular wave with a voltage amplitude (Vx+Vy) is applied between the first electrodes 19LX of the second electrode group 19 and the electrodes of the first electrode group 16 located in the part corresponding to the first electrodes 19LX, as shown in the upper side of FIG. 11B. On the other hand, a rectangular wave with a voltage amplitude Vx=Vy=(Vx+Vy)/2 is applied between the second electrodes 19SX of the second electrode group 19 and the electrodes of the first electrode group 16 located in the part corresponding to the second electrodes 19SX, as shown in the lower side of FIG. 11B. At this time, when the voltage amplitude is equal to or less than a threshold voltage of the liquid crystal, the movement of the liquid crystal molecules 13 is not actually caused in the part corresponding to the second electrodes 19SX, but the initial alignment distribution, that is, the refractive index distribution, of the liquid crystal molecules 13 can be caused by the transverse electric field due to the second electrodes 19SX.

FIG. 11C shows the potentials of the electrodes in the vertical direction corresponding to the state shown in FIG. 7A. Specifically, the upper side of FIG. 11C shows the voltage waveform of the part corresponding to the first electrodes 16LY of the first electrode group 16 and the lower side of FIG. 11C shows the voltage waveform of the part corresponding to the second electrodes 16SX.

When the state shown in FIG. 7A is realized, a predetermined potential difference allowing the liquid crystal molecules 13 to cause an alignment variation is generated in the part corresponding to the first electrodes 16LY of the first electrode group 16 between the upper and lower transparent electrodes with the liquid crystal layer 11 interposed therebetween.

Specifically, the switches, which are close to the Y-line generator 32, of the electrodes constituting the second electrode group 19 are all turned on to apply a common voltage (with an amplitude Vy) thereto. Among the plural electrodes constituting the first electrode group 16, only the first electrodes 16LY are connected to the X-line generator 31 to selectively apply the voltage (with an amplitude Vx) thereto. The second electrodes 16SY among the plural electrodes constituting the first electrode group 16 are grounded.

Here, when the X-line generator 31 and the Y-line generator 32 generate the voltages shown in FIG. 11A, a rectangular wave with a voltage amplitude (Vx+Vy) is applied between the first electrodes 16LY of the first electrode group 16 and the electrodes of the second electrode group 19 located in the part corresponding to the first electrodes 16LY, as shown in the upper side of FIG. 11C. On the other hand, a rectangular wave with a voltage amplitude Vx=Vy=(Vx+Vy)/2 is applied between the second electrodes 16SY of the first electrode group 16 and the electrodes of the second electrode group 19 located in the part corresponding to the second electrodes 16SY, as shown in the lower side of FIG. 11C. At this time, when the voltage amplitude is equal to or less than a threshold voltage of the liquid crystal, the movement of the liquid crystal molecules 13 is not actually caused in the part corresponding to the second electrodes 16SY, but the initial alignment distribution, that is, the refractive index distribution, of the liquid crystal molecules 13 can be caused by the transverse electric field due to the second electrodes 16SY.

When the entire liquid crystal layer 11 is set to the non-lens-effect state, it is preferable that the electrodes of the first electrode group 16 and the electrodes of the second electrode group 19 are set to have the same potential (0 V). That is, as shown in FIG. 4, the voltages generated from the X-line generator 31 and the Y-line generator 32 are set to 0 V to ground the electrodes. In this case, since the liquid crystal molecules 13 are aligned uniform in a predetermined direction defined by the alignment films 15 and 18, the non-lens-effect state is established.

### EXAMPLES

Specific examples of the smart phone 1 according to this embodiment will be described below.

In the liquid crystal lens array unit 10, as described above, the first electrode group 16 and the second electrode group 19 formed of ITO are formed on the first substrate 14 and the second substrate 17 formed of a glass material or the like by the use of a known photolithography method and a known wet etching or dry etching method. The alignment films 15 and 18 are formed by spin-coating the electrodes with polyimide and baking the resultant.

After baking the material, the surfaces of the alignment films 15 and 18 are subjected to the rubbing process, are washed with IPA or the like, and are then heated and dried. After cooling the resultant, the first substrate 14 and the second substrate 17 are bonded to each other with a distance of about 30 to 50 μm so that the rubbing directions thereof are opposite to each other. This distance is maintained by dispersing the spacers in the overall surface. Thereafter, a liquid crystal material is injected from the sealing member opening by the use of a vacuum injection method and the sealing member opening is closed. The liquid crystal cell is heated up to the isotropic phase and is slowly cooled.

MBBA (p-methoxybenzylidene-p′-butylaniline) which is a representative nematic liquid crystal is used as the liquid crystal material of the liquid crystal layer 11. The refractive index anisotropy Δn is 0.255 at 20° C.

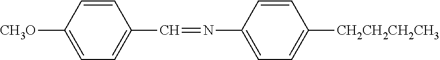

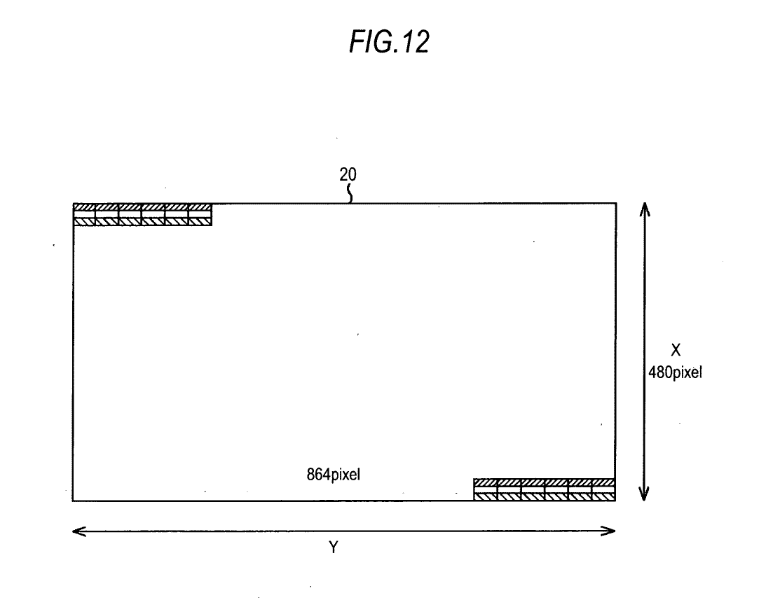

FIG. 12 shows an example of the display panel 20. In the display panel 20, pixels of R, G, and B are arranged in a matrix shape. The number of pixels in the display panel 20 is set to N (where N is an integer equal to or greater than 2) for the pitch p of cylindrical lenses formed in the liquid crystal lens array unit 10. In the area of the three-dimensional display mode, the light beams (the visual lines) corresponding to N are presented. A 3-inch TFT-LCD panel with a pixel size of 70.5 μm and a WVGA (864×480 pixels) scale is used as the display panel 20.

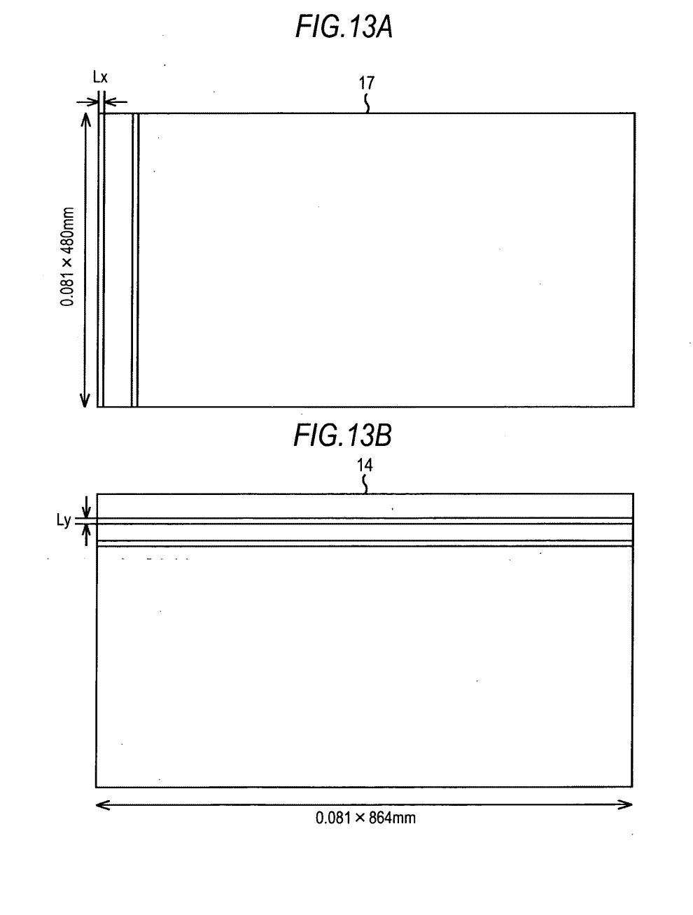

FIGS. 13A and 13B show the electrode structures of the liquid crystal lens array unit 10 according to first to third examples to be described later, where FIG. 13A shows the electrode structure of the second substrate 17 and FIG. 13B shows the electrodes structure of the first substrate 14. As shown in the drawings, the electrodes of the first substrate 14 and the electrodes of the second substrate 17 are perpendicular to each other in the first to third examples.

In this way, when the electrodes of the first substrate 14 and the electrodes of the second substrate 17 are perpendicular to each other, the following problem may be caused. That is, when the display panel 20 is used in the vertically-long state as shown in FIGS. 7A and 7B, a moiré may be easily generated in the three-dimensional display viewed by an observer due to the arrangement of the R, G, and B pixels in the display panel 20 in the X direction as shown in FIG. 12.

Therefore, to suppress the moiré from being generated in the three-dimensional display, the electrodes of the first substrate 14 and the electrodes of the second substrate 17 are not perpendicular to each other but have a predetermined angle in fourth to sixth examples to be described later.

FIGS. 14A and 14B show the electrode structures of the liquid crystal lens array unit 10 according to the fourth to sixth examples to be described later, where FIG. 14A shows the electrode structure of the second substrate 17 and FIG. 14B shows the electrodes structure of the first substrate 14. As shown in the drawings, the electrodes of the first substrate 14 and the electrodes of the second substrate 17 are formed to have an angle of (90−θ) in the fourth to sixth examples.

Here, θ satisfies tan⁻¹θ=1/3.

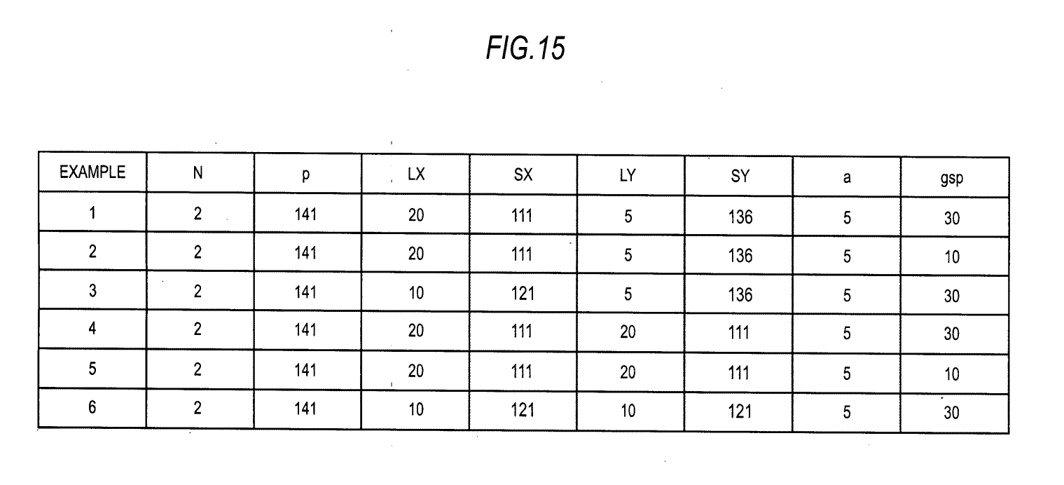

FIG. 15 shows values of various designed parameters corresponding to the first to sixth examples. N represents the number of pixels for each lens pitch p of the display panel 20, and the lengths of the electrode widths Lx, Sx, Ly, and Sy, the inter-electrode distance a, and the inter-substrate distance d shown in FIG. 2 are expressed in the unit of μm.

The power supplied from the X-line generator 31 and the Y-line generator 32 employs a rectangular waves with a frequency of 30 Hz or higher, and the voltage amplitude thereof is in the range of 5 to 10 V and is adjusted depending on the lens pitch p or the inter-substrate distance d. In general, as the inter-substrate distance d increases, it is necessary to set the voltage amplitude to a higher value.

Evaluations of the first to sixth examples will be described below. Since a clear criterion for determining the goodness and badness of the three-dimensional display is not presently generalized, it is used as the criterion for determining whether the three-dimensional display can be recognized by the use of the following simple technique.

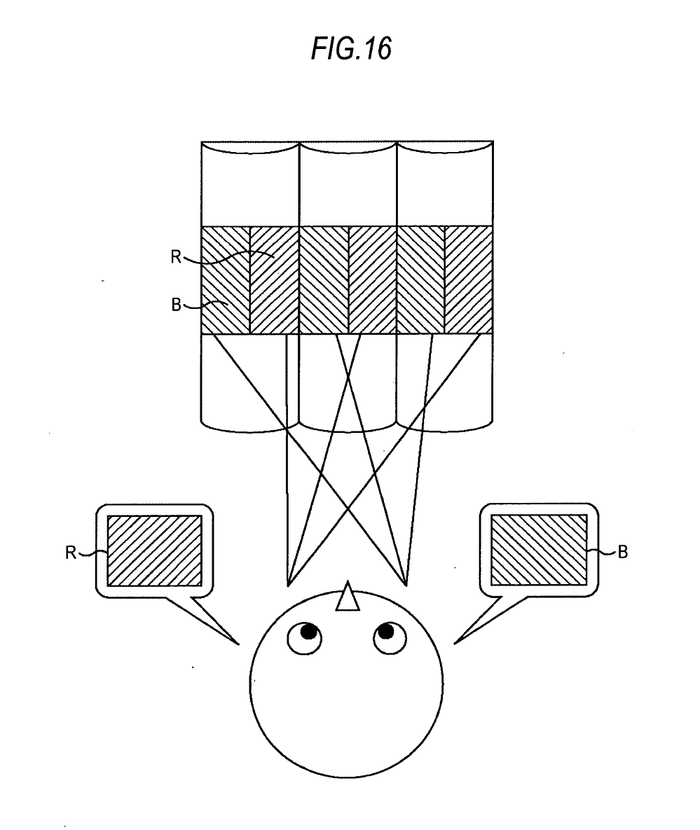

FIG. 16 shows the evaluation concept of the visual performance of the three-dimensional display in the first to sixth examples. As shown in the drawing, two pixels of a blue pixel and a red pixel correspond to a cylindrical lens generated by the liquid crystal lens array unit 10. As shown in the drawing, a display pattern allowing a right eye and a left eye to view blue and red, respectively, is output to the display panel 20 to display them. Cameras are disposed at positions corresponding to the right eye and the left eye to photograph the images and it is used as the criterion for determining whether red and blue are separately viewed. In an area of the two-dimensional display mode, red and blue are mixed and are viewed as violet.

Regarding the driving amplitude voltage, it gradually increases and the voltage value just before saturation where the visibility is hardly changed with the increase in voltage is used as the driving voltage. The voltage amplitude V of the rectangular wave applied to the electrodes is set to V=2Vx=2Vy. The time (2D-switching response time) during which the three-dimensional display mode is switched to the two-dimensional display mode by applying 0 V is observed also as an evaluation item.

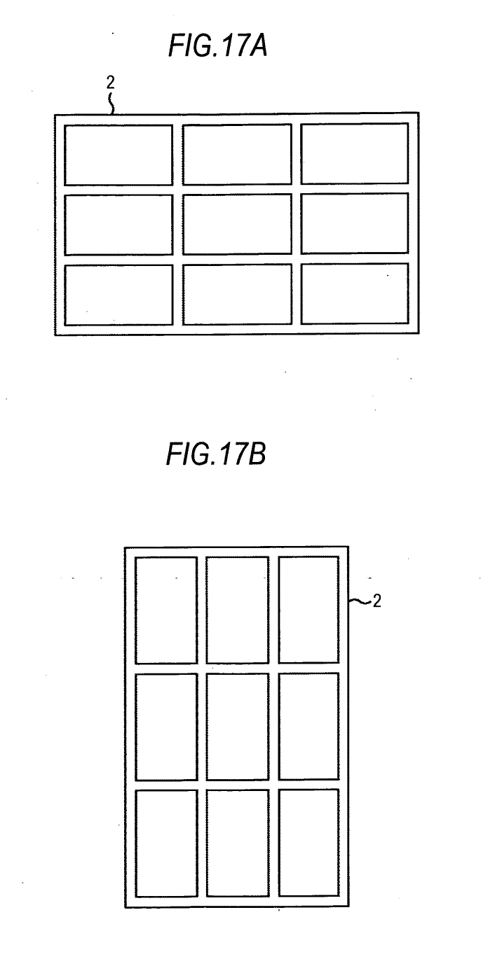

Regarding the position of the three-dimensional display area on the screen, as shown in FIGS. 17A and 17B, the screen is divided into 9 areas and the respective areas are sequentially set as the three-dimensional display area. As a result, even when any area is set as the three-dimensional display area in any state of the vertically-long state and the horizontally-long, it can be seen that the same lens effect is obtained.

The evaluation results of the first to sixth examples in the following five states are as follows.

Usage 1 (where the Overall Surface is Set to the Two-Dimensional Display Mode)

In all the first to sixth examples, the overall surface is viewed as violet in the visuality evaluation and the two-dimensional display can be seen as if the liquid crystal lens array unit 10 is not disposed on the display panel 20.

Usage 2 (where the Overall Surface is Set to the Three-Dimensional Display Mode in the Horizontally-Long State)

In all the first to sixth examples, red can be observed at the left-eye position and blue can be observed at the right-eye position. That is, it can be seen that the three-dimensional display mode is realized by the liquid crystal lens array unit 10.

Usage 3 (where the Overall Surface is Set to the Three-Dimensional Display Mode in the Vertically-Long State)

In all the first to sixth examples, red can be observed at the left-eye position and blue can be observed at the right-eye position. That is, it can be seen that the three-dimensional display mode is realized by the liquid crystal lens array unit 10. However, in the first to third examples, when white is displayed on the overall surface or the like, the so-called striped moiré of red, blue, and green is observed and thus the visual comfort is lack.

Usage 4 (where the Three-Dimensional Display Area is Disposed at the Center of the Screen in the Horizontally-Long State)

In all the first to sixth examples, violet is observed in the area of the two-dimensional display mode, regardless of the boundary position of the three-dimensional display mode and the two-dimensional display mode. On the other hand, in the area of the three-dimensional display mode, red can be observed at the left-eye position and blue can be observed at the right-eye position. That is, it can be seen that the three-dimensional display mode is realized by the liquid crystal lens array unit 10.

Usage 5 (where the Three-Dimensional Display Area is Disposed at the Center of the Screen in the Vertically-Long State)

In all the first to sixth examples, violet is observed in the area of the two-dimensional display mode, regardless of the boundary position of the three-dimensional display mode and the two-dimensional display mode. On the other hand, in the area of the three-dimensional display mode, red can be observed at the left-eye position and blue can be observed at the right-eye position. That is, it can be seen that the three-dimensional display mode is realized by the liquid crystal lens array unit 10. However, in the first to third examples, when white is displayed on the overall surface or the like, the so-called striped moiré of red, blue, and green is observed and thus the visual comfort is lack.

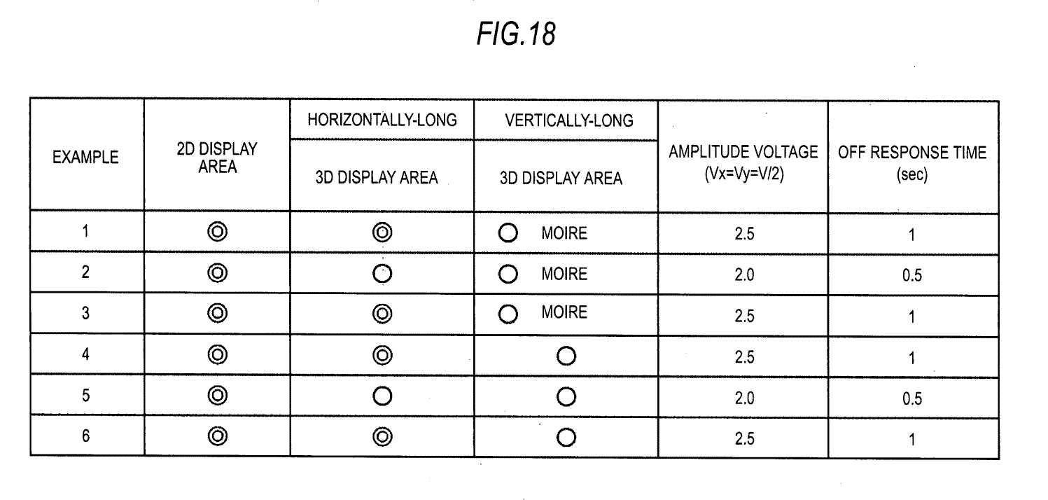

FIG. 18 shows the evaluation results of the first to sixth examples in Usages 1 to 5. In the drawing, the evaluation results of the two-dimensional display and the three-dimensional display are shown in four steps of a double circle, a single circle ◯, a triangle Δ, and a cross mark x sequentially from the best result. The double circle indicates that red and blue can be satisfactorily separately observed. The triangle Δ indicates that a critical state for separation of red and blue is observed. The single circle ◯ indicates that the visual performance is intermediate between the double circle © and the triangle Δ.

As described above, according to this embodiment, it is possible to make a three-dimensional display regardless of the orientation of the longitudinal direction of the screen, that is, not depending on whether it is used in the vertically-long state or in the horizontally-long state and to form a three-dimensional display area with any size at any position on the screen.

The present disclosure is not limited to the above-mentioned embodiment, but may be modified in various forms without departing from the concept of the present disclosure.

The present disclosure contains subject matter related to that disclosed in Japanese Priority Patent Application JP 2010-156649 filed in the Japan Patent Office on Jul. 9, 2010, the entire contents of which is hereby incorporated by reference.

What is claimed is:

1. A lens array unit comprising:
first and second substrates that are disposed to be opposite to each other with a distance interposed therebetween;
a first electrode group that is formed on the surface of the first substrate facing the second substrate and that has a configuration in which a plurality of electrodes extending in a first direction are arranged in parallel in the width direction at intervals;
a first switch group that connects a first voltage generator applying a voltage to the first electrode group to the electrodes of the first electrode group;
a second electrode group that is formed on the surface of the second substrate facing the first substrate and that has a configuration in which a plurality of electrodes extending in a second direction other than the first direction are arranged in parallel in the width direction at intervals;
a second switch group that connects a second voltage generator applying a voltage to the second electrode group to the electrodes of the second electrode group; and
a liquid crystal layer that is disposed between the first substrate and the second substrate, that contains liquid crystal molecules having refractive anisotropy, and that causes a lens effect by changing the alignment direction of the liquid crystal molecules depending on the voltages applied to the first electrode group and the second electrode group,
wherein the lens effect of the liquid crystal layer corresponding to an area specified by a line segment parallel to the first direction and a line segment parallel to the second direction is changed by switching the first and second switch groups.

2. The lens array unit according to claim 1, wherein the states of the voltages applied to the first electrode group and the second electrode group are changed by switching the first and second switch groups and the liquid crystal layer is electrically switched to anyone of a non-lens-effect state where the area specified by the line segment parallel to the first direction and the line segment parallel to the second direction does not cause the lens effect, a first lens state where the lens effect like a first cylindrical lens extending in the first direction is caused, and a second lens state where the lens effect like a second cylindrical lens extending in the second direction is caused.

3. The lens array unit according to claim 2, wherein the liquid crystal layer is switched to the non-lens-effect state when the plurality of electrodes of the first electrode group are the same potential as the plurality of electrodes of the second electrode group,
the liquid crystal layer is switched to the second lens state when a common voltage is applied to all the plurality of electrodes of the first electrode group and a driving voltage is selectively applied to only the electrodes located at positions corresponding to a lens pitch of the second cylindrical lens among the plurality of electrodes of the second electrode group, and
the liquid crystal layer is switched to the first lens state when a common voltage is applied to all the plurality of electrodes of the second electrode group and a driving voltage is selectively applied to only the electrodes located at positions corresponding to a lens pitch of the first cylindrical lens among the plurality of electrodes of the first electrode group.

4. The lens array unit according to claim 1, wherein the first electrode group includes a plurality of first electrodes extending in the first direction with a first width and a plurality of second electrodes extending in the first direction with a second width greater than the first width and has a configuration in which the first electrodes and the second electrodes are alternately arranged in parallel, and
the second electrode group includes a plurality of first electrodes extending in the second direction with a first width and a plurality of second electrodes extending the second direction with a second width greater than the first width and has a configuration in which the first electrodes and the second electrodes are alternately arranged in parallel.

5. The lens array unit according to claim 4, wherein the liquid crystal layer is switched to the non-lens-effect state when the plurality of electrodes of the first electrode group are the same potential as the plurality of electrodes of the second electrode group,
the liquid crystal layer is switched to the second lens state when a common voltage is applied to all the plurality of electrodes of the first electrode group and a driving voltage is selectively applied to only the first electrodes among the plurality of electrodes of the second electrode group, and
the liquid crystal layer is switched to the first lens state when a common voltage is applied to all the plurality of electrodes of the second electrode group and a driving voltage is selectively applied to only the first electrodes among the plurality of electrodes of the first electrode group.

6. The lens array unit according to claim 5, wherein the liquid crystal layer is switched to the second lens state when the driving voltage is selectively applied to only the first electrodes among the plurality of electrodes of the second electrode group and the second electrodes are grounded, and
the liquid crystal layer is switched to the first lens state when the driving voltage is selectively applied to only the first electrodes among the plurality of electrodes of the first electrode group and the second electrodes are grounded.

7. The lens array unit according to claim 6, wherein the liquid crystal layer is switched to the second lens state when the common voltage is applied to all the plurality of electrodes of the first electrode group and a second driving voltage is selectively applied to only the first electrodes among the plurality of electrodes of the second electrode group,
the liquid crystal layer is switched to the first lens state when the common voltage is applied to all the plurality of electrodes of the second electrode group and a first driving voltage is selectively applied to only the first electrodes among the plurality of electrodes of the first electrode group, and
the first driving voltage and the second driving voltage are rectangular waves having the same voltage amplitude and have a phase difference of 180°.

8. The lens array unit according to claim 4, wherein the first electrodes of the first electrode group are arranged at intervals corresponding to the lens pitch of the first cylindrical lens, and
the first electrodes of the second electrode group are arranged at intervals corresponding to the lens pitch of the second cylindrical lens.

9. The lens array unit according to claim 1, wherein the first direction and the second direction are perpendicular to each other, and
the liquid crystal layer is electrically switched to a lens-effect state in the first direction or a lens-effect state in the second direction.

10. The lens array unit according to claim 1, wherein the second direction intersects the first direction with an angle of (90°−θ), and
the liquid crystal layer is electrically switched to a lens-effect state in the first direction or a lens-effect state in the second direction.

11. The lens array unit according to claim 10, wherein θ satisfies tan⁻¹θ=1/3.

12. A lens array unit comprising:
first and second substrates that are disposed to be opposite to each other with a distance interposed therebetween;
a liquid crystal layer that is disposed between the first substrate and the second substrate;
a first electrode group that includes a plurality of electrode extending in a first direction;
a first switch group that connects a first voltage generator applying a voltage to the first electrode group to the electrodes of the first electrode group;
a second electrode group that includes a plurality of electrodes extending in a second direction other than the first direction; and
a second switch group that connects a second voltage generator applying a voltage to the second electrode group to the electrodes of the second electrode group,
wherein the liquid crystal layer corresponding to a specific area can be switched to a lens-effect state in the first direction or a lens-effect state in the second direction by switching the first and second switch groups.

13. An image display device comprising:
a display panel that makes a display of an image;
a lens array unit that is disposed to be opposite to the display surface of the display panel and that selectively changes a passing state of a light beam from the display panel;
detection means for detecting a direction in which the display panel disposed to be opposite to the lens array unit is used;
setting means for setting an area on a screen; and
switch control means for controlling switches,
wherein the lens array unit includes
first and second substrates that are disposed to be opposite to each other with a distance interposed therebetween,
a first electrode group that is formed on the surface of the first substrate facing the second substrate and that has a configuration in which a plurality of electrodes extending in a first direction are arranged in parallel in the width direction at intervals,
a first switch group that connects a first voltage generator applying a voltage to the first electrode group to the electrodes of the first electrode group,
a second electrode group that is formed on the surface of the second substrate facing the first substrate and that has a configuration in which a plurality of electrodes extending in a second direction other than the first direction are arranged in parallel in the width direction at intervals,
a second switch group that connects a second voltage generator applying a voltage to the second electrode group to the electrodes of the second electrode group, and
a liquid crystal layer that is disposed between the first substrate and the second substrate, that contains liquid crystal molecules having refractive anisotropy, and that causes a lens effect by changing the alignment direction of the liquid crystal molecules depending on the voltages applied to the first electrode group and the second electrode group, and
the switch control means switches the first and second switch groups on the basis of the detected direction in which the display panel is used and the set area on the screen, whereby the lens effect of the liquid crystal layer corresponding to the area is changed.

14. The image display device according to claim 13, wherein the states of the voltages applied to the first electrode group and the second electrode group are changed by switching the first and second switch groups and the liquid crystal layer is electrically switched to any one of a non-lens-effect state where the area specified by a line segment parallel to the first direction and a line segment parallel to the second direction does not cause the lens effect, a first lens state where the lens effect like a first cylindrical lens extending in the first direction is caused, and a second lens state where the lens effect like a second cylindrical lens extending in the second direction is caused.

15. The image display device according to claim 14, wherein a display state is electrically switched to a two-dimensional display or a three-dimensional display by switching the lens array unit to one of the non-lens-effect state, the first lens state, and the second lens state.

16. The image display device according to claim 15, wherein the two-dimensional display is made by setting the lens array unit to the non-lens-effect state and not deflecting but transmitting a display image beam from the display panel,
the three-dimensional display from which a stereoscopic effect can be obtained when both eyes are located in a direction perpendicular to the first direction is made by setting the lens array unit to the first lens state and deflecting the display image beam from the display panel to the direction perpendicular to the first direction, and
the three-dimensional display from which a stereoscopic effect can be obtained when both eyes are located in a direction perpendicular to the second direction is made by setting the lens array unit to the second lens state and deflecting the display image beam from the display panel to the direction perpendicular to the second direction.
